(19) United States
(12) Patent Application Publication
(10) Pub. No.: US 2013/0259282 A1
(43) Pub. Date: Oct. 3, 2013

(54) BACK CASE FOR A PORTABLE ELECTRONIC DEVICE

(71) Applicant: Yung-Jen Lin, Taichung City (TW)

(72) Inventor: Yung-Jen Lin, Taichung City (TW)

(21) Appl. No.: 13/736,747

(22) Filed: Jan. 8, 2013

(30) Foreign Application Priority Data
Mar. 28, 2012 (TW) 101205631

(51) Int. Cl. H04R 1/02

(52) U.S. Cl. CPC H04R 1/021
USPC 381/334

(57) ABSTRACT

A back case includes a main body adapted to be coupled detachably to a rear surface portion of a portable electronic device, and a sound guide member connected to the main body. the sound guide member a sound guide surface that is adapted to face the rear surface portion of the portable electronic device, that has a corrugated surface part corresponding in position to a speaker of the portable electronic device, and that cooperates with the rear surface portion of the portable electronic device to define a sound guide space having a forward-facing opening.

### CROSS-REFERENCE TO RELATED APPLICATION

This application claims priority of Taiwanese Application No. 101205631, filed on Mar. 28, 2012.

### BACKGROUND OF THE INVENTION

1. Field of the Invention

The invention relates to a back case, more particularly to a back case that is adapted to couple detachably to a portable electronic device and that has an opening for sound guidance.

2. Description of the Related Art

The recent expansion of the market for portable electronic devices, has changed how people access media. Users of these devices are now able to conveniently watch movies, listen to music, play computer games, and surf the web at any place and any time. Sound is an integral part of the media experience. However, because the electronic device, such as a tablet computer, generally utilizes a touch screen component for operation, to reduce the dimensions of the tablet computer for portability, often the speaker, charging port, and other components are installed along the edges of the rear surface of the tablet computer. Thus, when using the tablet computer, sound is directed away from the user which makes perception of the sound more difficult. Further, when using the portable electronic device in public, ambient noise often further decreases the user's ability to hear sound from the device. To ameliorate this problem, the user generally increases the volume of the device, which not only disturbs nearby people, but also increases the rate of battery usage and decreases the life span of the device.

FIGS. 1 to 3 illustrate a conventional back case 2 for a portable electronic device 1. The portable electronic device 1 includes a housing 1 that has a front surface portion 11 and a rear surface portion 12. The portable electronic device 1 is provided with a speaker 13 embedded in the rear surface portion 12. The conventional back case 2 included a main body 21 for being coupled detachably to the rear surface portion 12 of the portable electronic device 1 and a sound guide member 22 connected to the main body 21. The sound guide member 22 has a sound guide surface 22a that faces the speaker 13 when the back case 2 is coupled to the portable electronic device 1. When the back case 2 is coupled to the portable electronic device 1, the sound guide surface 22a operates with the rear surface portion 12 of the portable electronic device 1 to define a sound guide space with a forward-facing opening 22b.

With reference to FIG. 3, the speaker 13 emits sound waves (solid arrows) that are exit the opening 22b (dashed arrows). However, these sound waves are easily dispersed at the opening 22b. Moreover, referring to FIG. 4, because the curvature of the sound guide surface 22a corresponds to the curvature of the speaker 13, sound waves perpendicularly emitted from the speaker 13 (solid arrow) are also perpendicular to the curved sound guide surface 22a and are thus reflected back and forth between the sound guide surface 22a and the speaker 13 so that the sound waves never reach the opening 22b. Therefore, the conventional back case 2 is inefficient at guiding sound to the user.

### SUMMARY OF THE INVENTION

Therefore, the object of the present invention is to provide a back case that can alleviate the abovementioned drawbacks of the prior art.

Accordingly, a back case of the present invention is adapted to be coupled to a portable electronic device. The portable electronic device includes a housing that has front surface portion and a rear surface portion connected to the front surface portion, and a speaker that is embedded in the rear surface portion of the housing. The back case comprises a main body adapted to be coupled detachably to the rear surface portion of the housing of the portable electronic device, and a sound guide member connected to the main body. The sound guide member has a sound guide surface that is adapted to face the rear surface portion of the housing of the portable electronic device, that has a corrugated surface part corresponding in position to the speaker of the portable electronic device, and that cooperates with the rear surface portion to define a sound guide space having a forward-facing opening.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a conventional back case and a portable electronic device;

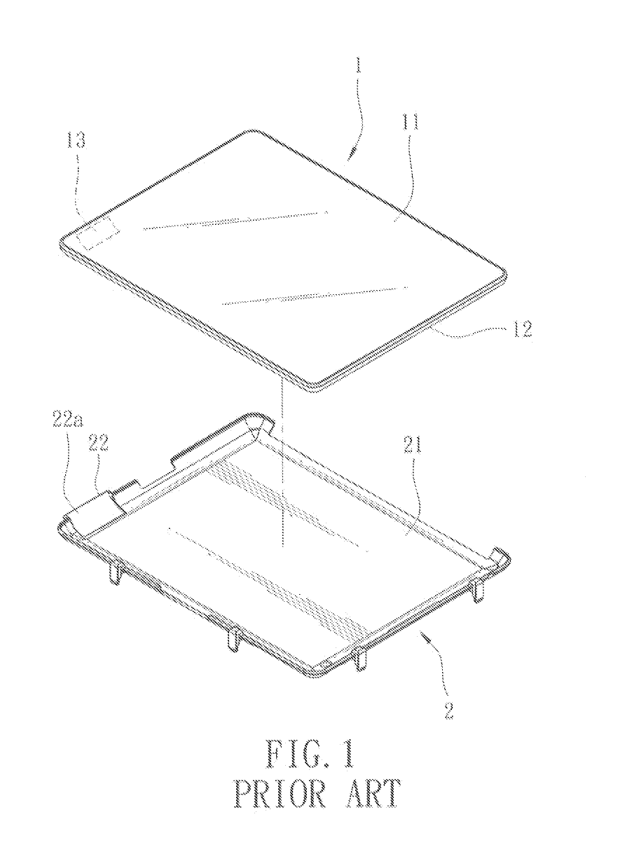

FIG. 2 is a perspective view of the conventional back case coupled to the portable electronic device;

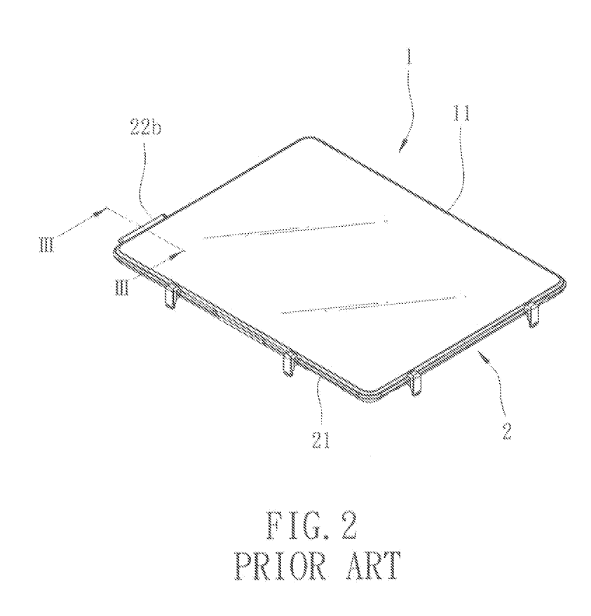

FIG. 3 is a fragmentary partly sectional view of the conventional back case and the portable electronic device taken along line III-III in FIG. 2, showing the guidance of sound;

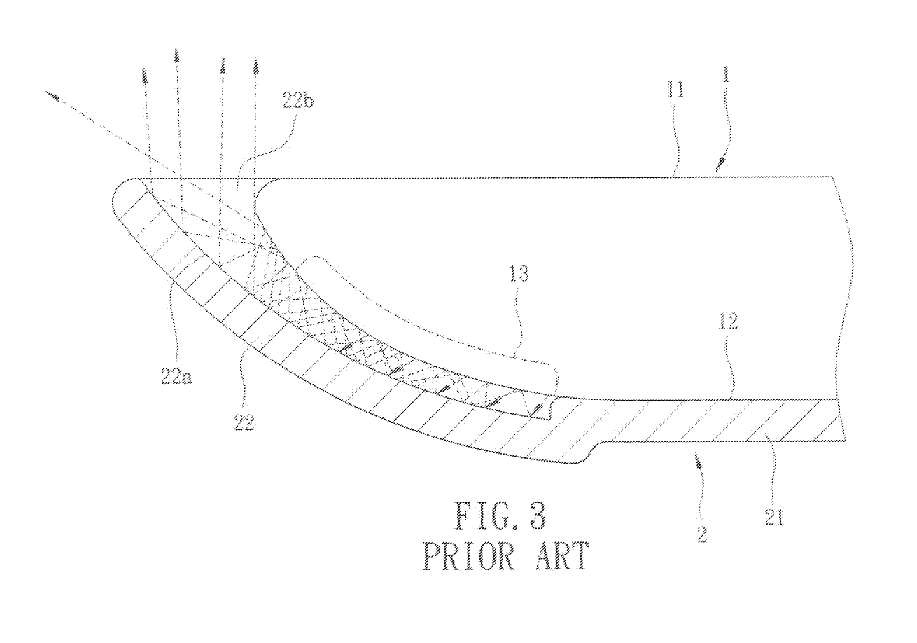

FIG. 4 is another fragmentary partly sectional view of the conventional back case and the portable electronic device, showing the inefficiency of the conventional back case;

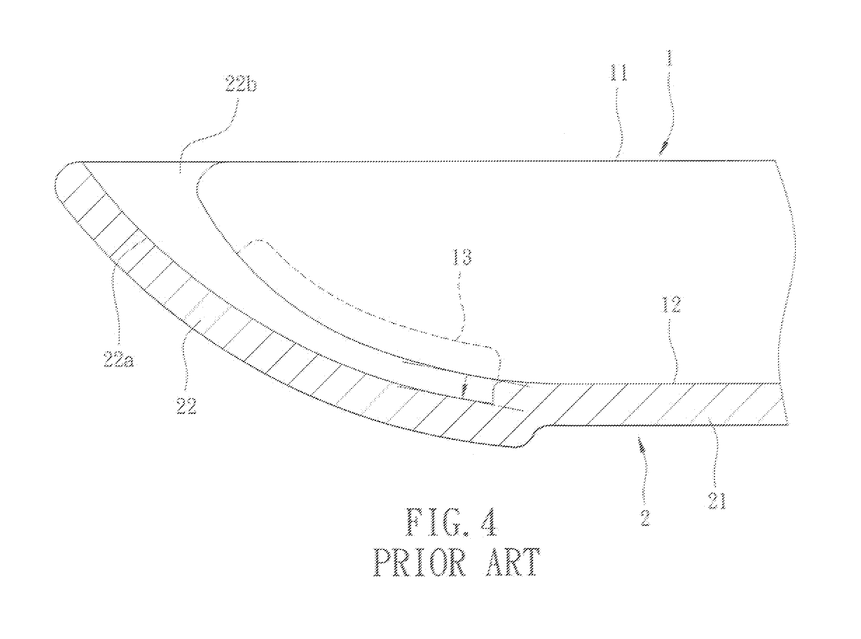

FIG. 5 is an exploded perspective view of a portable electronic device and a preferred embodiment of a back case according to the invention;

FIG. 6 is a perspective view of the preferred embodiment coupled to the portable electronic device;

FIG. 7 is a fragmentary partly sectional view of the preferred embodiment and the portable electronic device taken along line VII-VII in FIG. 6, showing the guidance of sound; and

FIG. 8 is another fragmentary partly sectional view of the preferred embodiment and portable electronic device, showing the inefficient guidance of sound.

### DETAILED DESCRIPTION OF THE PREFERRED EMBODIMENT

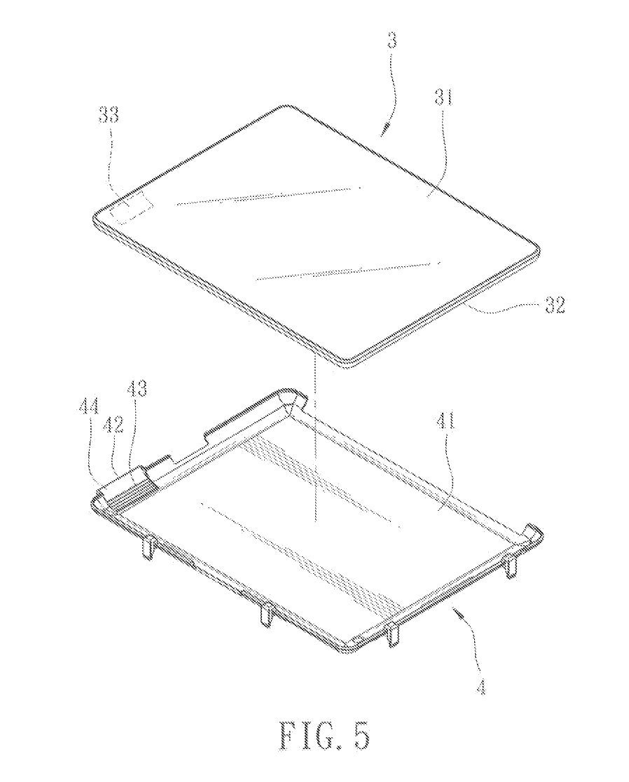

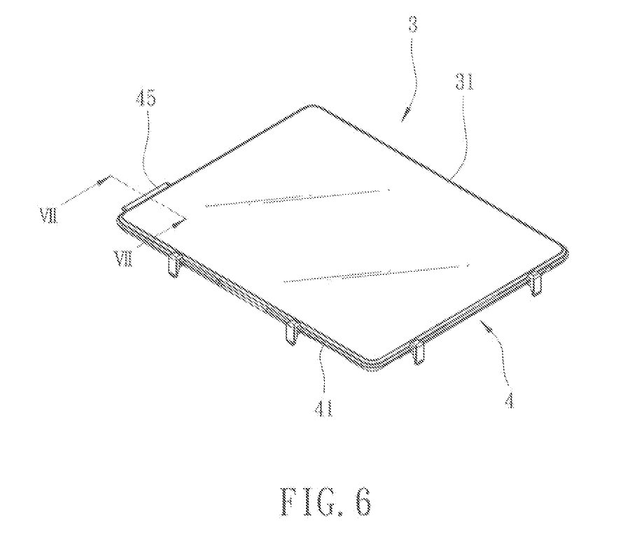

As shown in FIGS. 5 to 7, the preferred embodiment of back case 4 according to the present invention is adapted for being coupled detachably to a portable electronic device 3, such as a tablet computer. The portable electronic device 3 includes a housing that has a front surface portion 31 and a rear surface portion 32 connected to the front surface portion 31, and a speaker 33 embedded in the rear surface portion 32 of the housing. The back case 4 comprises a main body 41 adapted to be coupled detachably to the rear surface portion 32 of the housing of the portable electronic device 3, and a curved sound guide member 42 connected to the main body 41. The sound guide member 42 includes a sound guide surface 44 that has a corrugated surface part. When the back case 4 is coupled to the portable electronic device 3, the sound guide surface 44 faces the rear surface portion 32 of the portable electronic device 3 and cooperates with the rear surface portion 32 to define a sound guide space having a forward-facing opening 45, and the corrugated surface part 43 corresponds in position to the speaker 33 of the portable electronic device 3.

The corrugated surface part 43 of the sound guide surface 44 has a stepped configuration. Specifically, the corrugated surface part 43 has a plurality of spaced-apart reflecting surface sections 43a and a plurality of connecting surface sections 43b. The reflecting surface sections 43a extend substantially in a circumferential direction (V) of the sound guide member 42. Each of the connecting surface sections 43b interconnects an adjacent pair of the reflecting surface sections 43a. The curvature of a portion of the rear surface portion 32 of the portable electronic device 3 that confronts the sound guide space is configured to differ from that of the reflecting surface sections 43a of the sound guide member 42 such that the distance therebetween gradually increase toward the opening 45.

When coupling the back case 4 of this invention to the portable electronic device 3, the sound guide member 42 of the back case 4 is first registered with the speaker 33 of the portable electronic device 3, and then the back case 4 is pushed toward the portable electronic device to be completely coupled to the portable electronic device 3.

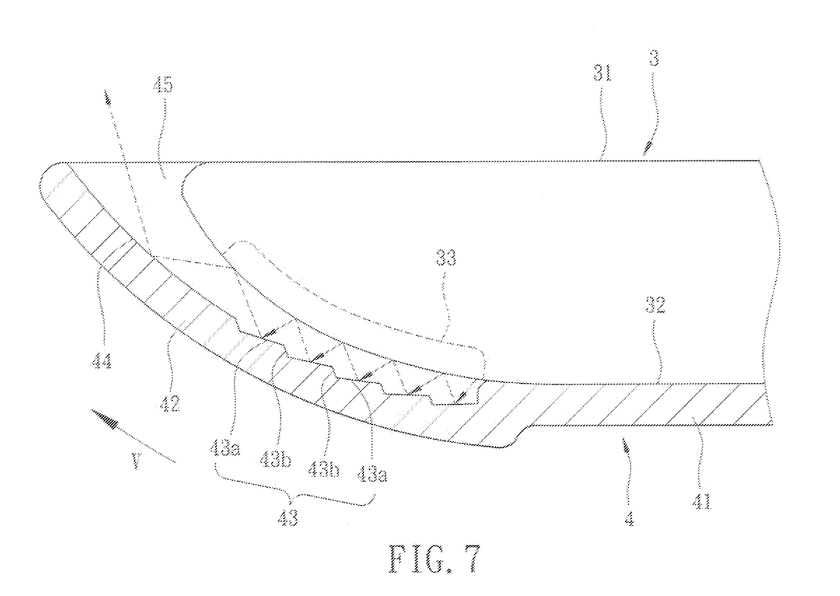

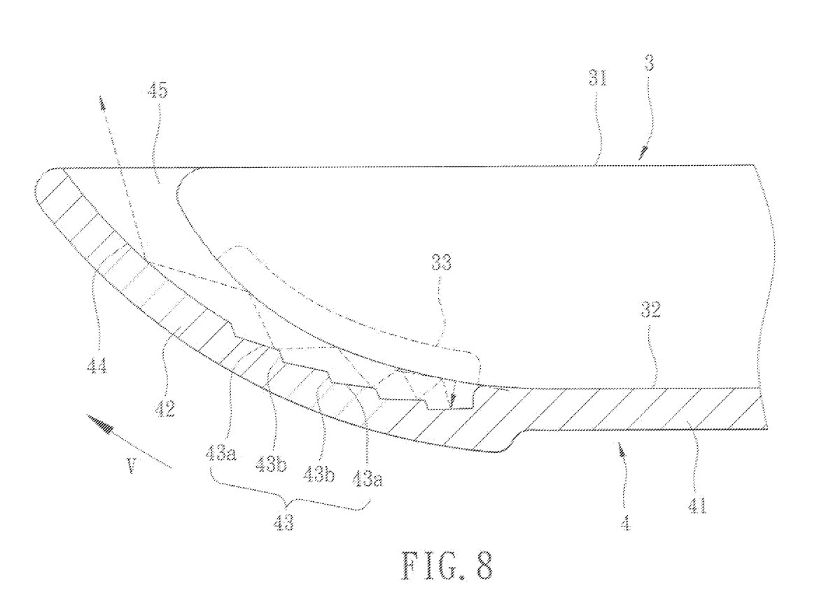

With reference to FIG. 7, by virtue of the corrugated surface part 43 of the sound guide member 42, sound waves emitted from the speaker 33 of the portable electronic device 3 (solid arrows) are reflected by the reflecting surface sections 43a and cumulatively exit the forward-facing opening 45 (dashed arrows). Additionally, due to the curvature differential between the reflecting surface sections 43a of the sound guide member 42 and the corresponding portion of the rear surface portion 32, with reference to FIG. 8, sound waves emitted perpendicularly from the rear surface portion 32 (solid arrow) are also reflected by the reflecting surface portion 43a at an angle (dashed arrow) such that they exit the sound guide space through the opening 45. Thus, the present invention is able to more effectively accumulate sound waves at the opening 45 due to the corrugated surface part 43, thereby allowing more sound to reach a user. Consequently, compared to the prior art, the user need not increase the volume as much to hear sounds emitted from the speaker 33, thereby reducing the risk of disturbing nearby people, decreasing the rate of battery usage, and increasing the life span of the portable electronic device.

It should be noted that although this invention is described in connection with a tablet computer, this invention may also be extended to cell phones, MP3 players, satellite navigation systems, and other portable electronic devices.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A back case adapted to be coupled detachably to a portable electronic device, the portable electronic device including a housing that has front surface portion and a rear surface portion connected to the front surface portion, and a speaker that is embedded in the rear surface portion of the housing, said back case comprising:
a main body adapted to be coupled detachably to the rear surface portion of the housing of the portable electronic device; and
a sound guide member connected to said main body, and having a sound guide surface that is adapted to face the rear surface portion of the housing of the portable electronic device, that has a corrugated surface part corresponding in position to the speaker of the portable electronic device, and that cooperates with the rear surface portion to define a sound guide space having a forward-facing opening.

2. The back case as claimed in claim 1, wherein said sound guide member is curved.

3. The back case as claimed in claim 2, wherein said corrugated surface part of said sound guide surface has a plurality of spaced-apart reflecting surface sections extending substantially in a circumferential direction of said sound guide member, and a plurality of spaced-apart connecting surface sections, each interconnecting an adjacent pair of said reflecting surface sections.

4. The back case as claimed in claim 3, a portion of the rear surface portion of the housing of the portable electronic device that confronting said sound guide space being curved with a curvature that is different from that of said sound guide member, wherein a distance between said sound guide surface and the portion of the rear surface increases toward said opening.

5. The back case as claimed in claim 1, wherein said corrugated surface part of said sound guide surface has a stepped configuration.

6. The back case as claimed in claim 5, wherein a distance between said sound guide surface and the portion of the rear surface increases toward said opening.
